(19) United States
(12) Patent Application Publication
(10) Pub. No.: US 2011/0228306 A1
(43) Pub. Date: Sep. 22, 2011

(54) IMAGE PROCESSING DEVICE AND PROGRAM

(75) Inventor: Masatoshi Matsuhira, Matsumoto-shi (JP)

(73) Assignee: SEIKO EPSON CORPORATION, Tokyo (JP)

(21) Appl. No.: 13/049,826

(22) Filed: Mar. 16, 2011

(30) Foreign Application Priority Data
Mar. 17, 2010 (JP) 2010-061666

(51) Int. Cl. G06F 3/12; G06K 9/36

(52) U.S. Cl. 358/1.13; 382/246

(57) ABSTRACT

An image processing device which encodes sequentially input image data, includes: a data converting unit that performs a preliminary process for encoding and converts the input image data into a predetermined data type to generate converted data; and an encoding unit that encodes the converted data using a predetermined Huffman table and constructs a new Huffman table on the basis of the converted data when a predetermined relationship is not satisfied between the input image data and preceding image data which is previously input and processed, and encodes the converted data using the new Huffman table constructed when encoding the preceding image data when the predetermined relationship is satisfied.

### BACKGROUND

1. Technical Field

The present invention relates to an image processing device and a program encoding sequentially input image data.

2. Related Art

As such a kind of image processing device, an image processing device in which image data compression processed by a JPEG method is processed is proposed (e.g., see JP-A-8-130649). In this device, when the compression processed image data is input, the image data is temporarily decoded and recompressed, and then the image data is stored in a memory device. At that time, a probability of occurrence of a DCT (discrete cosine transform) coefficient which can be obtained by the decoding of the image data is examined, a new Huffman table is reconstructed on the basis of the probability of occurrence, and the DCT coefficient is re-encoded using the reconstructed Huffman table, thereby performing a compression process. Accordingly, it is possible to raise the compression rate to minimize the amount of data.

In the above-described device, it is necessary to reconstruct the Huffman table every time before the encoding to raise the compression rate, and thus a waiting time for the reconstruction occurs, which may cause disturbance of a smooth compression process. On the other hand, although it is conceivable to use a predetermined Huffman table every time, in that case, the encoding cannot be efficiently performed according to the probability of occurrence of data values of compression target data, and thus it is difficult to raise the compression rate. In such a device, since both the compression rate and the processing speed are considered important, new improvements in the processing method are required.

### SUMMARY

An advantage of some aspects of the invention is to provide an image processing device and a program to raise the compression rate while achieving a smooth compression process of image data.

According to an aspect of the invention, there is provided an image processing device which encodes sequentially input image data, including: a data converting unit that performs a preliminary process for encoding and converts the input image data into a predetermined data type to generate converted data; and an encoding unit that encodes the converted data using a predetermined Huffman table and constructs a new Huffman table on the basis of the converted data when a predetermined relationship is not satisfied between the input image data and preceding image data which is previously input and processed, and encodes the converted data using the new Huffman table constructed when encoding the preceding image data when the predetermined relationship is satisfied.

In the image processing device according to the aspect of the invention, a preliminary process for encoding is performed and the input image data is converted into a predetermined data type to generate converted data, the converted data is encoded using a predetermined Huffman table and a new Huffman table is constructed on the basis of the converted data when a predetermined relationship is not satisfied between the input image data and preceding image data which is previously input and processed, and the converted data is encoded using the new Huffman table constructed when encoding the preceding image data when the predetermined relationship is satisfied. Accordingly, it is possible to efficiently perform the encoding and to raise the compression rate as compared with the case of encoding using the predetermined Huffman table. Since the new Huffman table constructed when encoding the preceding image data is used, it is possible to drastically reduce the processing time for constructing the Huffman table, as compared with the case of constructing the Huffman table at the time of encoding. As a result, it is possible to raise the compression rate while realizing a smooth compression process on image data.

In the image processing device according to the aspect of the invention, the encoding unit may perform the encoding, considering that the predetermined relationship is satisfied when an interval to the time of processing the input image data after encoding the preceding image data by the construction of the new Huffman table is within a predetermined time. The image data processed within the predetermined time has a high chance of being the same image data, and a tendency that the data values of the converted data are the same is high. Accordingly, it is possible to more appropriately perform the encoding by using the new Huffman table.

In the image processing device according to the aspect of the invention, the encoding unit may perform the encoding, considering that the predetermined relationship is satisfied when the preceding image data and the input image data are continuously input as one job formed of a plurality of image data. The sequentially input image data has a high chance of being the same image data, and a tendency that the data values of the converted data are the same is high. Accordingly, it is possible to more appropriately perform the encoding by using the new Huffman table.

The image processing device according to the aspect of the invention may further include an image type discriminating unit that discriminates types of image data, wherein the encoding unit may perform the encoding, considering that the predetermined relationship is satisfied when the type of the preceding image data and the type of the input image data discriminated by the image type discriminating unit coincide with each other. The image data in which the types of the image data coincide with each other has a high chance of being the same image data, and a tendency that the data values of the converted data are the same is high. Accordingly, it is possible to more appropriately perform the encoding by using the new Huffman table. As the types of the image data, for example, there are an image formed of text, an image formed of pictures, an image in which text and images are mixed, and the like.

In the image processing device according to the aspect of the invention, when the predetermined relationship is not satisfied, the encoding unit may perform the encoding using a default Huffman table as the predetermined Huffman table and may construct the new Huffman table as a Huffman table used to encode the subsequent image data.

The image processing device which generates printing data from image data input through an image reading device reading an image formed on a medium and outputs the printing data to a printing device, may further include a decoding unit that decodes the image data encoded by the encoding unit to generate decoded data and constructs the new Huffman table on the basis of the decoded data, to generate the printing data, wherein when the predetermined relationship is satisfied between the image data used to construct the new Huffman table by the decoding unit and the input image data, the encoding unit may perform the encoding using the new Huffman table constructed by the decoding unit instead of the new Huffman table constructed by the encoding. In this case, it is possible to increase an opportunity of constructing the new Huffman table, and to construct the new Huffman table at a more appropriate timing.

According to another aspect of the invention, there is provided a program for causing a computer to function as the image processing device of the aspect of the invention. This program may be recorded in a computer-readable recording medium (e.g., hard disk, ROM, FD, CD, DVD, etc.), may be transmitted from one computer to another computer through a transmission medium (communication network such as the Internet or LAN), and may be transmitted and received in other types. When the program is executed in the computer, it is possible to obtain the same advantages as those of the image processing device.

### BRIEF DESCRIPTION OF THE DRAWINGS

The invention will be described with reference to the accompanying drawings, wherein like numbers reference like elements.

FIG. 1 is a diagram illustrating a schematic configuration of a multi-function printer.

FIG. 2 is a flowchart illustrating an example of a process routine at the time of a copy mode.

FIG. 3 is a flowchart illustrating an example of a Huffman table setting process.

FIG. 4 is a diagram illustrating a relationship between a compression process of image data and the Huffman table used.

FIG. 5 is a flowchart illustrating an example of a Huffman table setting process of a modified example.

### DESCRIPTION OF EXEMPLARY EMBODIMENTS

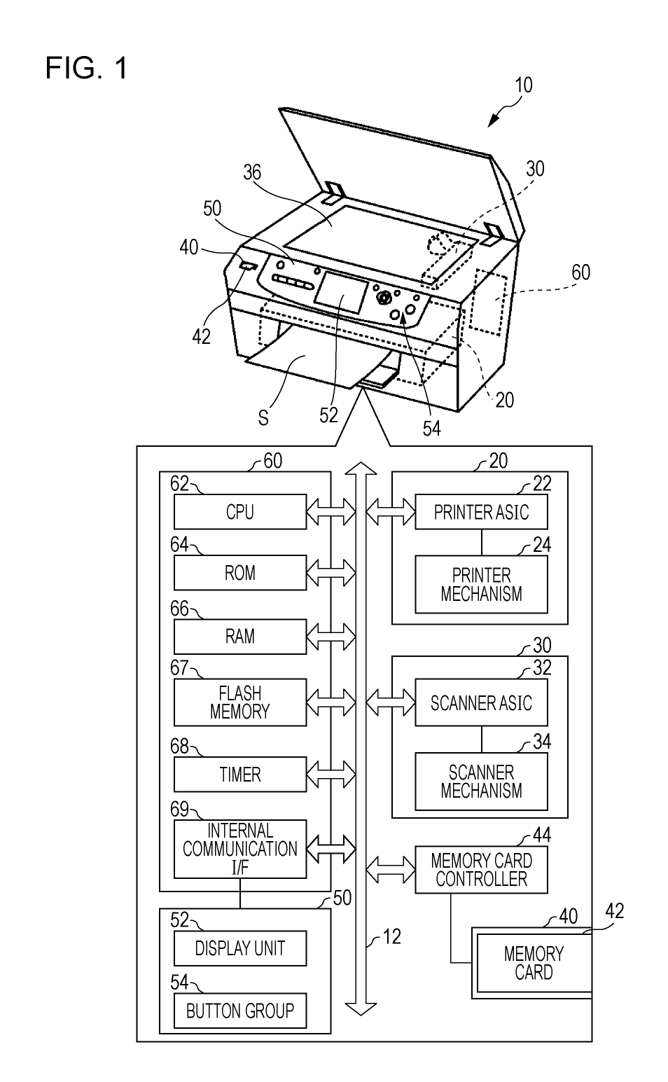

Hereinafter, embodiments of the invention will be described with reference to the drawings. FIG. 1 is a diagram illustrating a schematic configuration of a multi-function printer 10 that is an embodiment of an image processing device of the invention. As shown in FIG. 1, the multi-function printer 10 is provided with a printer unit 20 that performs printing on a sheet S on the basis of image data, a flatbed-type scanner unit 30 that reads a document placed on a glass base 36, a memory card controller 44 that inputs and outputs files storing data from and to a memory card 42 inserted to a memory card slot 40, an operation panel 50 that displays various types of information on a display unit 52 and inputs a user instruction through an operation of a button group 54, and a main controller 60 that controls the entire device. In the multi-function printer 10, the printer unit 20, the scanner unit 30, the memory card controller 44, and the main controller 60 can transmit and receive various controls signals or data through a bus 12.

The printer unit 20 is provided with a printer ASIC 22 and a printer mechanism 24. The printer ASIC 22 is an integrated circuit controlling the printer mechanism 24. When the printer ASIC 22 receives a printing instruction from the main controller 60, the printer ASIC 22 controls the printer mechanism 24 to print an image on the sheet S on the basis of the image data that is a target of the printing instruction. The printer mechanism 24 is formed of the known ink jet color printer mechanism performing the printing by ejecting ink from a printing head onto the sheet S.

The scanner unit 30 is provided with a scanner ASIC 32 and a scanner mechanism 34. The scanner ASIC 32 is an integrated circuit controlling the scanner mechanism 34. When the scanner ASIC 32 receives a reading instruction from the main controller 60, the scanner ASIC 32 controls the scanner mechanism 34 to read the document placed on the glass base 36, as image data. The scanner mechanism 34 is formed of the known image scanner, and is provided with the known color image sensor resolving reflected light after emitting light to the document of the colors of red (R), green (G), and blue (B), to become image data.

The memory card controller 44 inputs and outputs the files storing the data from and to the memory card 42 inserted to the memory card slot 40. The memory card controller 44 reads the files stored in the memory card 42 when the memory card 42 is connected to the memory card slot 40 and transmits the files to the main controller 60, or receives a command from the main controller 60 and stores the files in the memory card 42 on the basis of the command.

The main controller 60 is formed of a microprocessor based on a CPU 62, and is provided with a ROM 64 storing various process programs, various data, and various tables, a RAM 66 temporarily storing scanning data and printing data, a flash memory 67 capable of storing data even at the power-off time, a timer 68 used for counting, and an internal communication interface (I/F) 69 for communicating with the operation panel 50. The main controller 60 inputs various operation signals and various detection signals from the printer unit 20, the scanner unit 30, and the memory card controller 44, and inputs operation signals generated according to the operation of the button group 54 of the operation panel 50. The main controller 60 outputs a reading instruction of reading the files from the memory card 42 and outputting the files to the main controller 60, to the memory card controller 44, outputs a printing instruction to the printer unit 20 to print the image data, outputs a reading instruction to the scanner unit 30 to read the document placed on the glass base 36 on the basis of the scanning instruction of the button group 54 of the operation panel 50 as image data, and outputs a control instruction of the display unit 52 to the operation panel 50. Various modes can be selected by an operation of the button group 54 of the operation panel 50. As the selectable modes, for example, there are a copy mode of scanning and copying the document placed on the glass base 36 and a memory card mode of printing an image using the image data stored in the memory card 42 or scanning the document to become data and storing the data in the memory card 42.

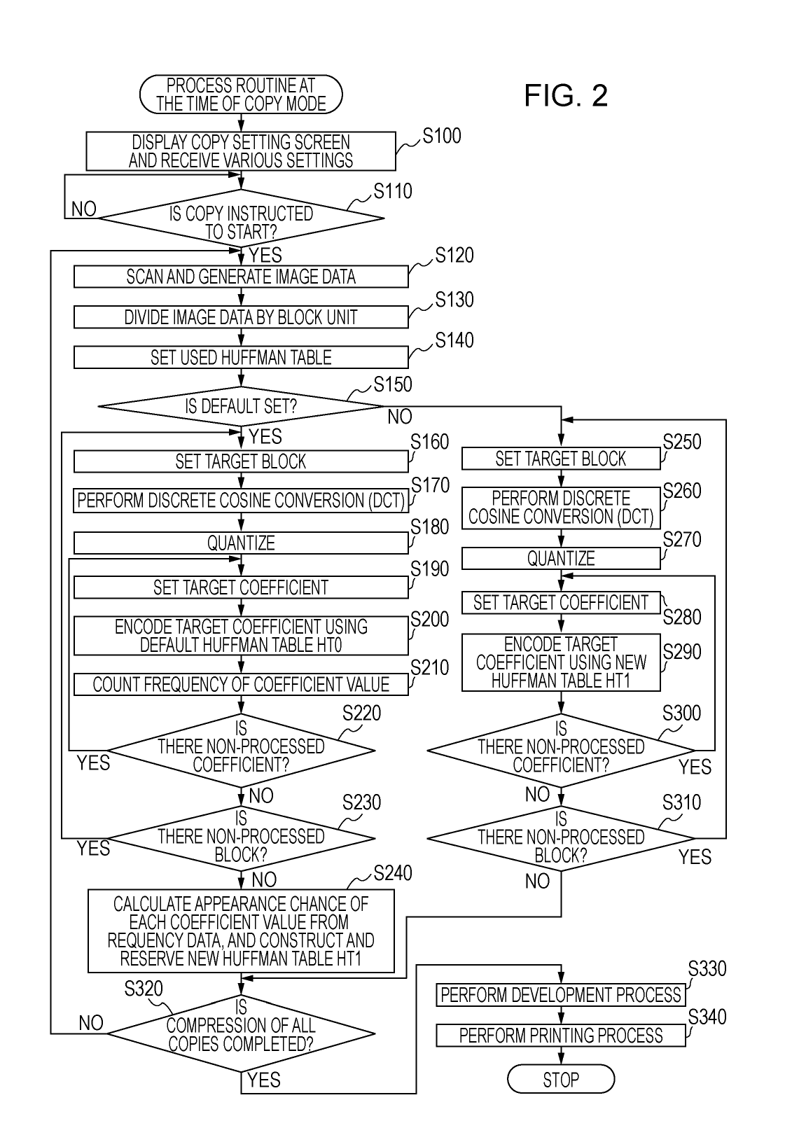

Next, an operation of the multi-function printer 10 of the embodiment configured as described above, particularly, an operation when selecting the copy mode will be described. FIG. 2 is a flowchart illustrating an example of a process routine at the time of the copy mode performed by the main controller 60. The routine is performed when the copy mode is selected by the operation of the button group 54 of the user.

When process routine is performed at the copy mode time, the CPU 62 of the main controller 60 firstly displays a copy setting screen capable of setting various items about copy on the display unit 52, and receives various settings by the operation of the button group 54 of the user (Step S100). Although the copy setting screen is not shown, as the settable items, there are settings for color or black-white copies, settings for the number of copies, settings for kinds of copy target documents such as “text”, “image”, or “text and image”, settings for the kinds of paper, and settings for the sizes of copy paper. In such settings, a case where the number of copies is set to 1 will be described.

When receiving the various settings through the copy setting screen and a copy starting instruction is achieved by the operation of the button group 54 (Step S110), the reading instruction is output to the scanner unit 30 to read to scan the document placed on the glass base 36 to generate image data (Step S120), and the generated image data of the RGB-color system is divided into block units (Step S130). As the blocks, for example, the image data is divided into the blocks in which one block is formed of 8×8 pixels. When the image data is divided into the block units, the data of the RGB-color system may be color-converted into data of a YUV-color system on the basis of a predetermined color conversion formula.

When the image data is divided into the block units as described above, a setting process of a Huffman table used in encoding described below is performed (Step S140). This process is a process of setting any of a default Huffman table HT0 stored in advance in the ROM 64 and a new Huffman table HT1 constructed by a process to be described later and stored in the flash memory 67, and details thereof will be described later. When the Huffman table is set, it is determined whether or not the default Huffman table HT0 is set (Step S150). Hereinafter, first, a case of setting the default Huffman table HT0 will be described.

When it is determined that the default Huffman table HT0 is set in Step S150, unprocessed blocks of the plurality of divided blocks are set to process target blocks (Step S160). The target blocks are set in order from the left upper block of the divided blocks in the image data to the right side. When there is no unprocessed block to the right side, the target blocks are set in order from the left end block at the next stage by one stage to the right side. Then, discrete cosine transform (DCT) is performed on the data values of the set target blocks to obtain DCT coefficients that are space frequency components (Step S170), and a quantization process is performed on the obtainable DCT coefficients using a quantization table stored in advance in the ROM 64 (Step S180). Subsequently, the DCT coefficients after the quantization are sequentially set to target coefficients of encoding (Step S190). The setting of the target coefficients is performed in order of so-called zigzag scanning, which scans the DCT coefficients in a zigzag from the left upper DCT coefficient in the block. The corresponding Huffman coding is set using the default Huffman table HT0 set in Step S140 to encode the target coefficients (Step S200), and the frequency of the target coefficients is counted (Step S210), and it is determined whether or not there is an unprocessed coefficient (Step S220). When it is determined that there is the unprocessed coefficient, returning to Step S190, the processes are repeated. In the encoding, generally, different Huffman tables are used in the left upper DCT coefficient (DC component) of the block and the other DCT coefficients (AC components) or different Huffman tables are used for each color component of the color system. However, in the embodiment, it is generally called the default Huffman table HT0 without discriminating such Huffman tables. The same is applied to the new Huffman table HT1.

When it is determined that there is no unprocessed coefficient in Step S220, it is determined whether or not there is an unprocessed block (Step S230). When it is determined that there is an unprocessed block, returning to Step S160, the processes are repeated. The encoded data and the count data of frequency are sequentially stored in the RAM 66, and information (in this case, the Huffman table HT0) of the type of the used Huffman table is registered in the encoded data. The encoding of the target coefficients and the counting of frequency are repeated, the processes of all the blocks are completed, and it is determined that there is no unprocessed block in Step S230. In this case, a probability of occurrence of each coefficient value of the DCT coefficients is calculated from the count data of frequency, and the new Huffman table HT1 is constructed according to the calculated appearance change and is stored in the flash memory 67 (Step S240). The construction of the new Huffman table HT1 may be performed by a method generally used in construction of a Huffman table, that is, the known method of assigning a short sign to a coefficient value with the highest probability of occurrence (occurrence frequency) and assigning a long sign to a coefficient value with a low occurrence probability. When there is the Huffman table HT1 stored in advance in the flash memory 67, it is stored by overwriting thereto. Accordingly, when the encoding is performed using the default Huffman table HT0, it is possible to construct the new Huffman table HT1 on the basis of the DCT coefficient after quantization considered as the target of the encoding.

When the new Huffman table HT1 is constructed as described above, it is determined whether or not a compression process of all numbers of copies is completed (Step S320). The number of copies is the number of copies which can be received through the copy setting screen of Step S100. In the embodiment, since it is assumed that the number of copies is set to 1, it is determined that the compression process of all the copies is completed in Step S320. The encoded data stored in the RAM 66 is developed and converted into image data (Step S330), a printing instruction is output to the printer unit 20 to perform a printing process based on the image data (Step S340), and the routine is completed. It is preferable that the development process of the encoded data be performed in an order reverse to the order of converting the image data into the encoded data, that is, in order of a decoding process, an inverse quantization process, and an inverse discrete cosine transform. As described above, since the information of the kind of the Huffman table is registered in the encoded data, the necessary Huffman table may be read on the basis of the information to perform the decoding process.

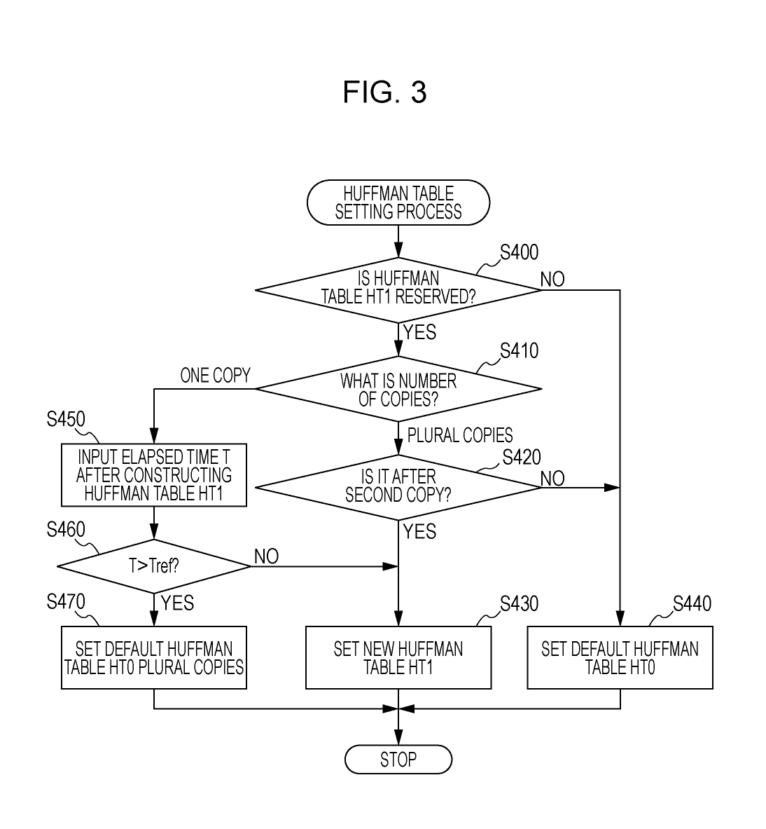

A case of making one copy again after one copy is completed as described above will be described. In the following description, to discriminate image data from the processing image data, the image data used to construct the Huffman table HT1 is called preceding image data. In this case, as described above, the processes of Steps S100 to S140 are firstly performed. That is, when receiving various settings through the copy setting screen and receiving the copy starting instruction, the scanning process is performed to generate image data, the generated image data is divided into block units, and a used Huffman table is set. Herein, the process routine at the copy mode time is not described, and the setting process of the Huffman table will be described. FIG. 3 is a flowchart illustrating an example of the Huffman table setting process.

In the Huffman table setting process routine, first, it is determined whether or not the new Huffman table HT1 is stored in the flash memory 67 (Step S400). When it is determined that the new Huffman table HT1 is not stored in the flash memory 67, the default Huffman table HT0 is set to a used Huffman table (Step S440), and the present process is completed. In this case, in the process routine at the copy mode time of FIG. 2, the encoding is performed using the default Huffman table HT0 as described above, and thus the new Huffman table HT1 at that time is constructed. Meanwhile, when the Huffman table HT1 has been already constructed for the preceding image data, it is determined that the Huffman table HT1 is stored in Step S400, and it is determined whether the present number of copies is plural or one (Step S410). Currently, since the number of copies is one, the number of copies is determined as one in Step S410. Then, a time T elapsed after the Huffman table HT1 is constructed is input (Step S450), and it is determined whether or not the elapsed time T exceeds a predetermined time Tref (Step S460). Herein, the elapsed time T is obtained by counting a time from the time point of constructing the new Huffman table HT1 by a counting process (not shown) using the timer 68, and is reset and newly counted when the Huffman table HT1 is constructed. The predetermined time Tref is set to the time of about several minutes. The multi-function printer 10 has a power saving mode of stopping supply of power to the display unit 52 when an operation signal is not input from the button group 54 during a regular time, and such a regular time may be set to the predetermined time Tref. The reason for setting such a time of several minutes as the predetermined time Tref will be described later. When it is determined that the elapsed time T does not exceed the predetermined time Tref in Step S460, the new Huffman table HT1 is set to the used Huffman table (Step S430), and the present process is completed. Meanwhile, when it is determined that the elapsed time T exceeds the predetermined time Tref, the default Huffman table HT0 is set (Step S470), and the present process is completed. The case of determining that the number of copies is plural in Step S410 will be described later.

Returning to the description of the process routine at the copy mode time, the case of setting the new Huffman table HT1 in Step S140 (Huffman table setting process of FIG. 3) will be described. In this case, the determination in Step S150 is negative, target blocks of the divided blocks are set (Step S250), the discrete cosine transform (DCT) is performed on each data value of the set target blocks (Step S260), the quantization process is performed on the DCT coefficients (Step S270), and the DCT coefficients after the quantization are sequentially set to the target coefficients (Step S280). The processes of Steps S250 to S280 are performed in the same manner as Steps S160 to S190 of setting the default Huffman table HT0. When the target coefficients are set in such a manner, the set target coefficients are encoded using the Huffman table HT1 until there is no unprocessed coefficient (Steps S290 and S300). When there is no unprocessed coefficient in the target blocks, it is determined whether or not the next unprocessed block is present (Step S310). When it is determined that the unprocessed block is present, returning to Step S250, the processes are repeated. Meanwhile, when it is determined that there is no unprocessed block, it is determined that the compression process of all the copies is completed in Step S320, the encoded data is developed to generate printing data in Step S330, a printing process is performed in Step S340, and the present routine is completed.

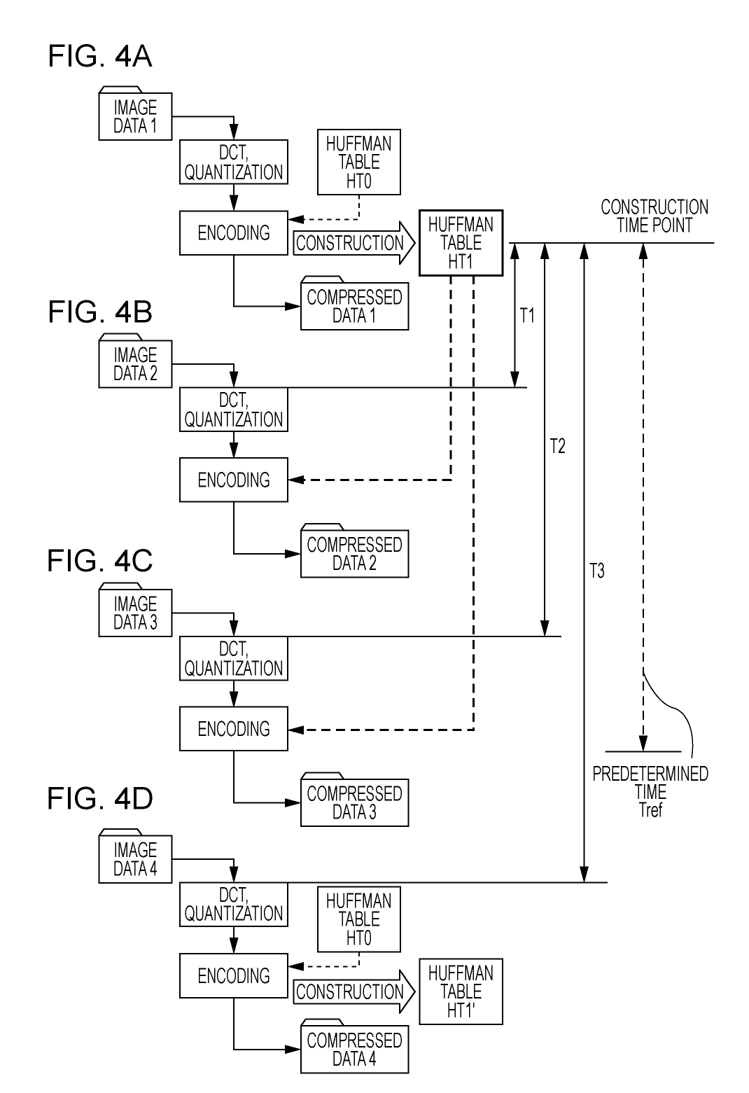

Hereinafter, the relationship between the compression process (encoding) of the image data and the used Huffman table will be described with reference to FIG. 4. FIGS. 4(1) to (4) show that the preceding image data 1 and the subsequent image data 2 to 4 are processed in time series order. It is assumed that the Huffman table HT1 is not stored at the time of processing the image data 1. The process routine at the copy mode time includes the process of developing and printing the compressed image data. However, in FIG. 4, from the when the data is input until the compressed data is generated is simplified and shown. As shown in FIG. 4, first, to process the image data 1, the compressed data 1 is generated using the Huffman table HT0, and at this time, the new Huffman table HT1 is constructed. Then, to process the image data 2, since the elapsed time T1 from the time point of constructing the Huffman table HT1 to the starting time of the process (the discrete cosine transform (DCT)) of the image data 2 is equal to or less than the predetermined time Tref, the image data 2 is encoded using the Huffman table 1. As described above, also in the case of processing the image data 3, since the elapsed time T2 from the time point of constructing the Huffman table HT1 to the process starting is less than the predetermined time, the encoding is thus performed using the Huffman table HT1. Meanwhile, when the image data 4 is processed, the elapsed time T3 from the time point of constructing the Huffman table HT1 to the process starting time exceeds the predetermined time Tref, and thus the encoding is performed using the Huffman table HT0 which is not the Huffman table HT1. In this case, the Huffman table HT1 (and HT1′ shown) is newly constructed.

As described above, when copying in which the number of copies is one is repeatedly performed, any of the default Huffman table HT0 and the new Huffman table HT1 is set to the used Huffman table according to whether or not the elapsed time T from the time point of constructing the Huffman table HT1 at the processing time of the preceding image data to the time (the time point of dividing the image data into the block units and starting the DCT) of starting the process for the encoding in the subsequent image data exceeds the predetermined time Tref, and the subsequent image data is encoded using the set Huffman table. As described above, the predetermined time Tref is set to the time of about several minutes. The possibility that the copying performed within such a time is copying performed by the same user at once is high, and it may be assumed that the same document is copied. For this reason, the contents of the preceding image data and the subsequent image data are similar, and the possibility that the occurrence probabilities of the coefficient values of the DCT coefficient after the quantization are similar is high. Accordingly, the case of encoding the subsequent image data using the Huffman table HT1 is a process using the appropriate Huffman table by the occurrence probabilities of the coefficient values of the DCT coefficient, and it is possible to efficiently perform the encoding, as compared with the case of the encoding using the default Huffman table HT0. Meanwhile, when the elapsed time T exceeds the predetermined time Tref, the possibility that the copying of the same document is performed is low. Accordingly, the advantage of using the new Huffman table HT1 is small as compared with the case where the elapsed time T is equal to or less than the predetermined time Tref. For this reason, such a case copes with the copying after reconstructing the new Huffman table HT1. When the number of copies is 1, the Huffman table corresponding to the elapsed time T after constructing the Huffman table HT1 is set for such a reason. Since the Huffman Table HT1 is constructed when performing the encoding using the default Huffman table HT0, it is possible to drastically reduce the processing time for constructing the Huffman table HT1, as compared with the case of constructing the Huffman table when performing the encoding.

Next, it is thought that the number of copies is plural. First, the Huffman table setting process of FIG. 3 when the number of copies is plural will be described. In this case, it is determined that the number of copies is plural in Step S410, and then it is determined whether or not the current process is the second copy or later (Step S420). When the present process is not the second copy or later, that is, the first copy, the default Huffman table HT0 is set in Step S440 and the present process is completed. Meanwhile, when the present process is the second copy or later, the new Huffman table HT1 is set in Step S430 and the present process is completed.

In the process routine at the copy mode time of FIG. 2, first, it is determined that the default Huffman table HT0 is set in Step S150 for the first copying process, and the processes of Steps S160 to S240, that is, the processes of counting the frequency of the coefficients while the coefficient values of the DCT coefficient after the quantization are encoded using the default Huffman table HT0, and of constructing and storing the Huffman table HT1 are performed. When it is determined that the compression of all the copies is not completed in Step S320, returning to Step S120 and the processes are repeated. Then, in the processes of the second copy or the later, the Huffman table HT1 constructed and stored in the first copying process is set to the used Huffman table in Step S140 (the Huffman table setting process of FIG. 3), it is determined that the Huffman table HT1 is set in Step S150, and the processes of Steps S250 to S310, that is, the process of encoding the coefficient values of the DCT coefficient after the quantization using the new Huffman table HT1 is performed. The processes of the second copy or the later are performed until the compression of the image data of all the copies is completed. When the compression of all the copies is completed, the printing process is performed on the basis of the image data developed in Steps S330 and S340, and the present routine is completed. That is, in such a plurality of copies, since the printing is started after the image data of all the copies are compressed, the preceding image data and subsequent image data are continuously input as one job formed of the plurality of image data. As described above, in the plurality of copies, the Huffman table HT1 constructed for the encoding of the preceding image data (the first copy) is used in the encoding of the subsequent image data (the second copy or the later), and thus it is possible to efficiently encode the subsequent image data as compared with the case of using the default Huffman table HT0. The construction of the Huffman table HT1 is performed only at the time of encoding the preceding image data, and is not performed at the time of encoding the subsequent image data. Accordingly, it is possible to drastically reduce the processing time for constructing the Huffman table HT1 as compared with the case of constructing the Huffman table at the encoding time.

Herein, correspondence between the constituent elements of the embodiment and the constituent elements of the invention will be clarified. The main controller 60 performing Steps S130, S160 to S180, and S250 to S270 in the process routine at the copy mode time of FIG. 2 corresponds to the “data converting unit” of the invention, and the main controller 60 performing Steps S140, S150, S190 to S210, S240, S280, and S290 in the process routine at the copy mode time of FIG. 2 and the Huffman table setting process of FIG. 3 corresponds to the “encoding unit”. The main controller 60 performing the process of Step S330 in the process routine at the copy mode time of FIG. 2 corresponds to the “decoding unit”.

According to the multi-function printer 10 of the embodiment described above, when one copy is copied and when the Huffman table HT1 is not stored or the elapsed time T from the time point of constructing the Huffman table HT1 exceeds the predetermined time Tref even when the Huffman table HT1 is stored, the encoding is performed on the DCT coefficient after the quantization using the default Huffman Table HT0 and the new Huffman table HT1 is constructed on the basis of the probability of occurrence of the coefficient values of the DCT coefficient. When the elapsed time T from the time point of constructing the Huffman table HT1 to the time of starting the process of the subsequent image data is equal to or less than the predetermined time Tref, the encoding is performed on the DCT coefficient after the quantization using the new Huffman table HT1. Accordingly, it is possible to raise the compression rate as compared with the case of performing the encoding using the default Huffman table HT0 and to drastically reduce the processing time for construction as compared with the case of constructing the Huffman table at the encoding time. Even when the plurality of copies are copied, the Huffman table HT1 constructed for the encoding of the preceding image data (the first copy) is used in the encoding of the subsequent image data (the second copy or the later). Accordingly, it is possible to efficiently encode the subsequent image data and to drastically reduce the processing time for the construction since it is not necessary to construct the Huffman table HT1 at the time of encoding the subsequent image data, as compared with the case of using the default Huffman table HT0. As a result, it is possible to raise the compression rate while achieving the smooth compression process of the image data.

The invention is not limited to the above-described embodiment, and may be modified to various types within the technical scope of the invention.

In the embodiment, the time from the time point of constructing the Huffman table HT1 to the time point of starting the division into the block units in the subsequent image data is used as the elapsed time T, but the invention is not limited thereto, for example, from the time point of constructing the Huffman table HT1 to the time point of inputting the subsequent image data, and from the time point of constructing the Huffman table HT1 to the time point of starting the encoding of the subsequent image data.

In the embodiment, the flatbed-type scanner unit 30 is used, but an automatic document feeder (ADF)-type scanner unit may be used. In this case, a document is continuously scanned and image data continuously input as one job is accumulated and processed, and thus it may be processed in the same manner as the copying of the plurality of copies of the embodiment.

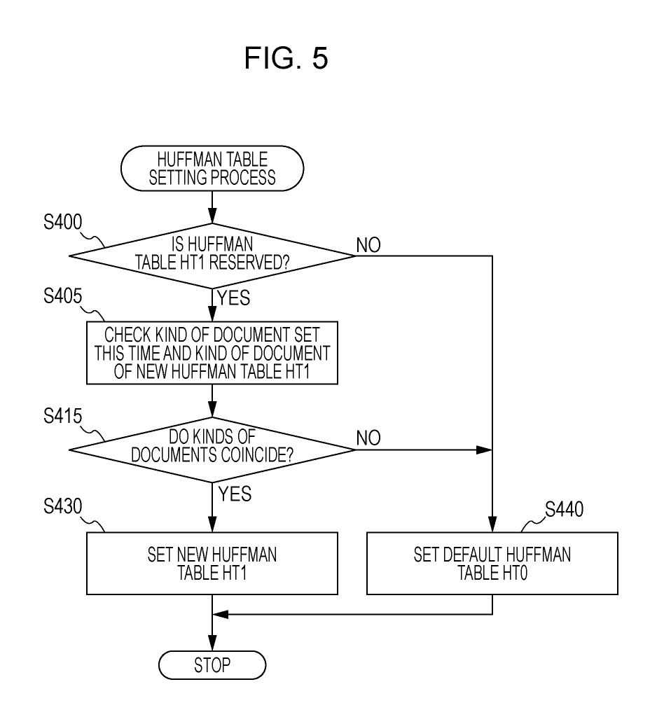

In the embodiment, the Huffman table used is set on the basis of the number of copies or on the basis of the elapsed time T from the time point of constructing the Huffman table HT1, but the invention is not limited thereto, and the Huffman table may be set on the basis of various settings other than the number of copies. For example, the Huffman table may be set on the basis of types of a copy target document (“text”, “image”, and “text and image”). In this case, a Huffman table setting process of a modified example shown in FIG. 5 may be performed instead of the Huffman table setting process of FIG. 3. In FIG. 5, the same reference numerals and signs are given to the same processes as those of FIG. 3. In the Huffman table setting process of the modified example, when it is determined that the Huffman table HT1 is stored in Step S400, the types of the document such as “text”, “image”, and “text and image” set in current process and the kind of the document set in the process of the preceding image data used in the construction of the new Huffman table HT1 are combined (Step S405), and it is determined whether or not the types of the documents coincide with each other (Step S415). To combine the types of the documents, in the process of Step S240 of the process routine at the copy mode time of FIG. 2, when the Huffman table HT1 is stored, it is preferable to store it according to the information of the set types of the document. When it is determined that the types of the documents coincide with each other in Step S415, the Huffman table HT1 is set in Step S430, and the process is completed. When it is determined that the types of the documents do not coincide with each other, the default Huffman table HT0 is set in Step S440, and the process is completed. When the types of the documents coincide with each other, the possibility that the probability of occurrence of the DCT coefficient of the encoding target will become similar is high. Accordingly, the same effect of the embodiment is obtained by performing the encoding using the newly constructed Huffman table HT1 instead of the default Huffman table HT0. When the Huffman table HT1 is stored according to the information of the types of the documents at that time, the information is kept even when the power of the multi-function printer 10 is turned off. Accordingly, even when the power is thereafter turned on and the copying process is performed, it is possible to set the Huffman table HT1 on the basis of the types of the documents.

In the embodiment, the compression process is performed irrespective of the number of copies, but the invention is not limited thereto. For example, when the number of copies is one, the compression process may not be performed, and when the number of copies is plural, the compression process may be performed. In this case, in the Huffman table setting process of FIG. 3, the processes of Steps S410 and S450 to S470 may be omitted.

In the embodiment, the Huffman table HT1 is constructed when the encoding is performed, but the invention is not limited thereto, and the Huffman table HT1 may be constructed when decoding is performed. In this case, it is preferable that the frequency of the coefficient values of the DCT coefficient obtainable by the decoding is counted, the probability of occurrence of the coefficient values is calculated from the frequency data, and the new Huffman table HT1 is constructed on the basis of the calculated probability of occurrence and is stored in the flash memory 67. The Huffman table HT1 constructed at the decoding time may be set to a Huffman table used for the encoding in the Huffman table setting process. In this case, it is possible to increase the opportunity of constructing the Huffman table HT1 and to construct the Huffman table HT1 at a more appropriate timing while considering processing load or the like of the encoding process or the decoding process.

In the embodiment, the constructed Huffman table HT1 is used for the encoding of the subsequent image data, but the invention is not limited thereto, and may be used for the encoding of the image data used for the construction of the Huffman table HT1.

In the embodiment, the image processing device of the invention is applied to the operation at the copy mode time, but may be applied to an operation at the time of the memory card mode of compressing image data obtainable by scanning a document in the memory card 42.

In the embodiment, the image processing device of the invention is applied to the multi-function printer 10 capable of copying with the printer unit 20 and the scanner unit 30, but the invention is not limited thereto. For example, the image processing device may be applied to a scanner device provided with only a scanner unit, and may be applied to a digital camera or a mobile phone with a camera, which perform a compression process on a captured image.

In the embodiment, one Huffman table is stored as the new Huffman table HT1 in the flash memory 67, but the invention is not limited thereto, and a plurality of Huffman tables may be stored. For example, one Huffman table for each type of document may be stored.

In the embodiment, the JPEG method of compressing still images is described by way of example, but a MPEG method of compressing movies may be applied as long as it is a compression method of performing the encoding using the Huffman table.

What is claimed is:

1. An image processing device which encodes sequentially input image data, comprising:
a data converting unit that performs a preliminary process for encoding and converts the input image data into a predetermined data type to generate converted data; and
an encoding unit that encodes the converted data using a predetermined Huffman table and constructs a new Huffman table on the basis of the converted data when a predetermined relationship is not satisfied between the input image data and preceding image data which is previously input and processed, and encodes the converted data using the new Huffman table constructed in encoding the preceding image data when the predetermined relationship is satisfied.

2. The image processing device according to claim 1, wherein the encoding unit performs the encoding, considering that the predetermined relationship is satisfied when an interval until processing the input image data after encoding the preceding image data by the construction of the new Huffman table is within a predetermined time period.

3. The image processing device according to claim 1, wherein the encoding unit performs the encoding, considering that the predetermined relationship is satisfied when the preceding image data and the input image data are continuously input as one job formed of a plurality of image data.

4. The image processing device according to claim 1, further comprising an image type discriminating unit that discriminates types of image data,
wherein the encoding unit performs the encoding, considering that the predetermined relationship is satisfied when the type of the preceding image data and the type of the input image data discriminated by the image type discriminating unit coincide with each other.

5. The image processing device according to claim 1, wherein when the predetermined relationship is not satisfied, the encoding unit performs the encoding using a default Huffman table as the predetermined Huffman table and constructs the new Huffman table as a Huffman table used to encode the subsequent image data.

6. The image processing device according to claim 1, which generates printing data from image data input through an image reading device reading an image formed on a medium and outputs the printing data to a printing device, further comprising a decoding unit that decodes the image data encoded by the encoding unit to generate decoded data and constructs the new Huffman table on the basis of the decoded data, to generate the printing data,
wherein when the predetermined relationship is satisfied between the image data used to construct the new Huffman table by the decoding unit and the input image data, the encoding unit performs the encoding using the new Huffman table constructed by the decoding unit instead of the new Huffman table constructed by the encoding.

7. A storage medium storing a program for causing a computer to function as the image processing device according to claim 1.
